(19) United States
(12) Patent Application Publication
(10) Pub. No.: US 2024/0075716 A1
(43) Pub. Date: Mar. 7, 2024

(54) BAG COMPRISING A BI-DIRECTIONALLY ORIENTED POLYETHYLENE FILM

(71) Applicant: SABIC GLOBAL TECHNOLOGIES B.V., BERGEN OP ZOOM (NL)

(72) Inventors: Franciscus Petrus Hermanus SCHREURS, Beek (NL); Niclasina Siberta Johanna Alberdina GERRITS, Sittard (NL); Bart VAN DEN ESSCHERT, Sittard (NL); Attilio SCALA, Maastricht (NL); Lucio BACCARO, Isernia (IT)

(21) Appl. No.: 17/767,537

(22) PCT Filed: Oct. 9, 2020
(86) PCT No.: PCT/EP2020/078419

§ 371 Date: Apr. 8, 2022

(30) Foreign Application Priority Data
Oct. 10, 2019 (EP) 19202382.8
Oct. 10, 2019 (EP) 19202385.1
Oct. 10, 2019 (EP) 19202387.7
Oct. 10, 2019 (EP) 19202390.1
Oct. 10, 2019 (EP) 19202396.8
Oct. 10, 2019 (EP) 19202402.4
Oct. 10, 2019 (EP) 19202410.7

(51) Int. Cl. B32B 27/08; B32B 27/32

(52) U.S. Cl. CPC B32B 27/08; B32B 27/32; B32B 2250/02; B32B 2250/246; B32B 2307/31; B32B 2307/518; B32B 2307/72; B32B 2307/732; B32B 2307/75; B32B 2323/04; B32B 2439/46

(57) ABSTRACT

The present invention relates to a bag comprising a film, wherein the film comprises at least a first layer, wherein the first layer is a bi-directionally oriented polyethylene film layer, wherein the bag comprises ≥90.0 wt % of polyethylene with regard to the total weight of the film. Such bag may be used for packaging of bulk goods or for packaging of frozen matter. Such bag demonstrates a desirably high retention of mechanical properties and shape under load, at reduced weight as compared to bags of the art, and presents a mono-material solution allowing suitable further processing of the bag via recycling technologies.

The present invention relates to a bag for packaging bulk products, also referred to as heavy-duty bags, or for packaging of frozen matter, comprising a bi-directionally oriented polyethylene film. In the context of the present invention, the bag may also be referred to as the package.

In the field of packaging, there is an ongoing need for reduction of the quantity of material that is used to manufacture the package. Such reduction clearly provides benefits in that the package will have a lower weight, utilises less materials resources, and, after having ended its service life, will result in a reduced quantity of waste.

In a great variety of packaging applications, the package as a whole, or a part of a package, may be manufactured from polymer films. In particular, polyethylene materials are suitable and widely employed materials in all sorts of packaging.

In order to reduce the weight of a polyethylene film, one option is to reduce the thickness of the film. However, typically a reduction of thickness of such film leads to a deterioration of the properties of the film, such as its mechanical properties.

A means of increasing the mechanical properties of a polyethylene film of reduced thickness is to manufacture such film starting from a film having a higher thickness, and subjecting this film to an orientation process at temperatures below the melting point of the polyethylene material. Such orientation thus results in the film being stretched, as a result of which the thickness of the film is reduced.

Such orientation typically is performed via a bi-directional orientation process, wherein first a film is produced via cast film extrusion, which is then, after cooling to below the melting temperature, subjected to a stretching force to induce orientation in the machine direction, i.e. the direction in which the film is manufactured in the film extrusion process, and subsequently subjected to a stretching force in the transverse direction, i.e. to direction perpendicular to the machine direction in the plane of the film.

Such bi-directionally oriented polyethylene film may have film properties, such as mechanical properties, that are far superior to those of a polyethylene film having a similar thickness, but produced via conventional film production processes such as cast extrusion or blown film production, wherein the film is not subjected to stretching at temperatures below the melting point of the film.

In the field of packaging, there are certain properties that packages desirably comply with in order to suitably qualify for a given type of packaging application. A particular property for certain applications in this regard is the retention of mechanical properties and shape under load. For example, where the package is a bag for containing bulk goods, such bag, which commonly is referred to as a heavy-duty bag, is during its service life typically subjected to forces that are exerted onto the bag due to its internal load as well as due to external loads. Such internal load typically is the bulk matter packed in the bag, and external loads may be exerted when multiple bags are stacked onto pallets. This is a typical approach in logistics of heavy-duty bags.

It is also required that, in order to qualify for use under such conditions, a package demonstrates at least a desirably good puncture resistance, tear resistance, and, where a seal is applied to a package such as a thermal seal, a good seal integrity at such low temperatures.

A further aspect that contributes to the requirements for such heavy-duty bags relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt % of polymer material of the same class, or even at least 97 wt %. Such package it typically referred to as a mono-material package.

So, this presents yet a further requirement on solutions for heavy-duty bags, in that they desirably comprise at least 90 wt % of polymer material of the same class.

A particular property for certain applications in this regard is the retention of mechanical properties at reduced temperatures to which a package may be subjected, such as during use in deep-freezing applications, where temperatures typically reach up to −30° C. It is required that, in order to qualify for use under such conditions, a package demonstrates at least a desirably good puncture resistance, tear resistance, and, where a seal is applied to a package such as a thermal seal, a good seal integrity at such low temperatures.

In storing frozen matter, the matter to be stored is typically provided in portions that can be individually used by the consumer. For example, for consumer products such as food products, a portion of the product is to be contained such that the consumer may obtain that portion in a simple manner, whilst ensuring that during production, storage and use of the contained portion of matter, the matter is not subjected to detrimental conditions from the outside environment to which the contained portion of matter is subjected. That is, the portion of matter is to be packed in such way that the package maintains a closed system until the removal of the matter from the package is desired.

One widely used way of packaging such matter for storage in deep-frozen conditions is in the form of containing it in sealed bags. Typically, such bags are produced out of polymer film materials.

A further aspect that contributes to the requirements for such frozen matter packaging materials relates to the recyclability of the materials that are used in the package. Given the ongoing desire to increase the fraction of package material that can be subjected to recycling processes, in order to reduce waste and consumption of raw materials, there is a desire to produce packages that are suitable to be recycled. One particular manner to contribute to this objective is by ensuring that the polymer materials that are used in packages that are produced from polymer film materials are of the same class of polymers. In recycling technologies, film materials that comprise multiple types of polymers are unsuitable for a certain number of method of recycling. The more uniform the composition of a stream of material for recycling, the more suitable for recycling such stream is.

Therefore, it is desirable to ensure that the package comprises a certain high fraction of polymer material that belongs to one and the same class of materials. Typically, it is desirable that the package comprises at least 90 wt %, or at least 95 wt % of polymer material of the same class, or even at least 97 wt %. Such package it typically referred to as a mono-material package.

So, this presents yet a further requirement on solutions for packaging of frozen food materials, in that they desirably comprise at least 90 wt % of polymer material of the same class.

As can be understood, it is desirable that a bag demonstrates a particularly high degree of retention of mechanical properties and shape under load and reduction of the weight of the bag, as well as having appropriate cold temperature properties, whilst also providing a mono-material solution. To achieve this remains the subject of developments, and has now been achieved according to the present invention by a bag for packaging bulk products comprising a film, wherein the film comprises at least a first layer, wherein the first layer is a bi-directionally oriented polyethylene film layer, wherein the bag comprises ≥90.0 wt %, preferably ≥95.0 wt %, preferably ≥97.0 wt %, of polyethylene with regard to the total weight of the film.

Such bag demonstrates a desirably high retention of mechanical properties and shape under load, at reduced weight as compared to bags of the art, and presents a mono-material solution allowing suitable further processing of the bag via recycling technologies.

The film as used in the bag of the invention may be a single-layer film. Alternatively, the film may be a multi-layer film, where the multiple layers are formed by lamination of the first layer and at least one further bi-directionally oriented polyethylene film layer to form a laminate. For example, such laminate may comprise 2, 3, 4 or 5 bi-directionally oriented polyethylene film layers.

The layers may for example be bonded together via lamination, preferably wherein the bonding occurs via an adhesive layer positioned between each of the layers. Such adhesive layer may for example be in the form of a polyurethane-based adhesive, wherein the adhesive may be a solvent-based adhesive or a solvent-free adhesive.

The laminate may be formed by applying the adhesive to a surface of one of the layers that are to be adhered to each other, and contacting that surface to a surface of a further film layer, preferably by applying a contact pressure. Such lamination may be performed in a continuous process, where the film to which the adhesive is applied is contacted with the other film, wherein the contact pressure is provided by continuously rotating nip rollers, following which the laminate is spooled onto a roll.

In an alternative embodiment, the adhesive is a melt adhesive, which is applied to a film surface in molten form. Such melt adhesive may for example be a thermoplastic material that demonstrates appropriate adhesion to both the first and the second film. For example, such melt adhesive may be a polyethylene-based material. This embodiment provides a further advantages in that the content of polyethylene material in the laminate is increased, and thereby the suitability of the materials for recycling as mono-material product. Particularly, such polyethylene-based material that may be used as melt adhesive may be a functionalised polyethylene, such as a maleic anhydride-grafted polyethylene. Such polyethylene demonstrates excellent adhesive properties, and thereby is particularly suitable for production of high-quality laminates.

Each layer may for example have a thickness of ≥15 and ≤75 μm, preferably ≥20 and ≤70 μm, even more preferably ≥30 and ≤60 μm, or of ≥15 and ≤50 μm, for example ≥15 and ≤40 μm, such as ≥15 and ≤30 μm, or ≥20 and ≤40 μm.

For example, when the bag is made of a single-layer film, the layer that constitutes that film may have a thickness of ≥30 and ≤70 μm, preferably ≥30 and ≤60 μm, even more preferably ≥40 and ≤60 μm. For example, where the bag is a laminate comprising 2 layers of the bi-directionally oriented polyethylene film, each layer may have a thickness of ≥15 and ≤40 μm, such as ≥20 and ≤40 μm, and preferably both layers are of the same thickness. For example, where the bag is a laminate comprising 3, 4 or 5 layers of the bi-directionally oriented polyethylene film, each layer may have a thickness of ≥15 and ≤30 μm, and preferably all layers are of the same thickness.

In the context of the present invention, a bi-directionally oriented film is to be understood to be a film that is formed by cast extrusion, and subjected to orientation in the machine direction and in the transverse direction of the film production line, at a temperature below the melting temperature of the material of the film.

In the package of the invention, the laminated film is preferably positioned such that, the first layer is positioned towards the inside of the package, when compared to second layer, and the second layer is positioned towards the outside of the package, when compared to the first layer.

A printed layer may be provided in the laminate on the surface of the first layer that is positioned towards the outside of the package.

In the context of the present invention, bi-directionally oriented films are to be understood to be films that have been produced by drawing a film both in the machine direction (MD), which is the direction in which the film is extruded from an extrusion process, and in the transverse direction (TD), which is the direction perpendicular to the MD in the plane of the film. The bi-directional drawing can be done sequentially or simultaneously. Such drawing is to be applied at a drawing temperature of below the melting point of the film.

The polymer as used in the bi-directionally oriented film has a density of ≥910 and ≤930 kg/m³. Preferably, the polymer has a density of ≥910 and ≤925 kg/m³. More preferably, the polymer has a density of ≥915 and ≤925 kg/m³. Even more preferably, the polymer has a density of ≥916 and ≤925 kg/m³, or even more preferably ≥916 and ≤922 kg/m³.

The polymer as used in the bi-directionally oriented film has a melt mass-flow rate determined at 190° C. under a load of 2.16 kg, also referred to as MFR2, of ≥0.2 and ≤5.0 g/10 min, preferably ≥0.5 or ≥0.6, and ≤5.0 g/10 min, preferably ≥0.5 or ≥0.6, and ≤4.0 g/10 min, more preferably ≥0.8 and ≤3.5 g/10 min, even more preferably ≥1.0 and ≤3.0 g/10 min, even more preferably ≥1.0 and ≤2.5 g/10 min.

The polymer as used in the bi-directionally oriented film particularly is characterised by its a-TREF fingerprint, that is, it has a particular distribution of the fractions of polymer that in a-TREF are eluted in particular defined temperature ranges in which the fractionation is performed. In particular, the polymer according to the invention has a fraction eluted in a-TREF at a temperature>94.0° C. of ≥20.0 wt %, with regard to the total weight of the polymer. More preferably, the polymer has a fraction eluted >94.0° C. of ≥25.0 wt %, even more preferably ≥30.0 wt %, yet even more preferably ≥35.0 wt %.

In the field of polyethylenes, the fraction of polymer that is eluted in a-TREF at a temperature of >94.0° C. reflects the quantity of linear polymeric material that is present in the particular polymer. In the present polymer, having a particular quantity of the material in this fraction, this indicates that a certain amount of linear polymeric material is to be present.

Further, the polymer as used in the bi-directionally oriented film has a fraction that is eluted in a-TREF at a temperature≤30.0° C. of ≥8.0 wt %, with regard to the total weight of the polymer. The fraction that is eluted at a temperature of ≤30° C. may in the context of the present invention be calculated by subtracting the sum of the fraction eluted >94° C. and the fraction eluted >30° C. and ≤94° C. from 100%, thus the total of the fraction eluted ≤30° C., the fraction eluted >30° C. and ≤94° C. and the fraction eluted >94° C. to add up to 100.0 wt %. The fraction eluted ≤30° C. preferably is ≥9.0 wt %, more preferably ≥10.0 wt %, even more preferably ≥11.0 wt %.

Preferably, the fraction that is eluted in a-TREF at a temperature≤30.0° C. is ≥8.0 and ≤16.0 wt %, more preferably ≥9.0 and ≤14.0 wt %, even more preferably ≥10.0 and ≤14.0 wt % with regard to the total weight of the polymer; and/or preferably, the fraction that is eluted in a-TREF at a temperature>94.0° C. is ≥20.0 and ≤50.0 wt %, more preferably ≥25.0 and ≤45.0 wt %, even more preferably ≥30.0 and ≤40.0 wt %, with regard to the total weight of the polymer; and/or preferably, the fraction that is eluted in a-TREF at a temperature>30.0° C. and ≤94.0° C. is ≥40.0 and ≤64.0 wt %, more preferably ≥45.0 and ≤60.0 wt %, even more preferably is ≥45.0 and ≤55.0 wt %.

It is preferred that the weight fraction that is eluted in a-TREF at a temperature of >30.0° C. and ≤94.0° C. is greater than the weight fraction that is eluted in a-TREF at a temperature of >94.0° C. Preferably, the fraction eluted >30.0° C. and ≤94.0° C. is at least 5.0 wt % greater than the fraction eluted >94.0° C., wherein the fractions are expressed with regard to the total weight of the polymer.

According to the invention, analytical temperature rising elution fractionation, also referred to as a-TREF, may be carried out using a Polymer Char Crystaf-TREF 300 with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution was performed with a heating rate of 1° C./min from 30° C. to 140° C. The set-up was cleaned at 150° C.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl)butane and 1 g/l tri(2,4-di-tert-butylphenyl) phosphite) at a temperature of 150° C. for 1 hour, and optionally further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

In the context of the present invention, the CCDB is determined according to formula I:

$$C C D B = \frac{{T}_{z + 2} - {T}_{n - 2}}{{T}_{n - 2}} * 100 \qquad formula 1$$

wherein
   Tₙ₋₂ is the moment calculated according to the formula II:

$${T}_{n - 2} = \frac{\sum \frac{w ( i )}{{T ( i )}^{2}}}{\sum \frac{w ( i )}{{T ( i )}^{3}}} \qquad formula 11$$

and
   T_{z+2} is the moment calculated according to the formula III:

$${T}_{z + 2} = \frac{\sum w ( i ) \cdot {T ( i )}^{4}}{\sum w ( i ) \cdot {T ( i )}^{3}} \qquad formula 111$$

wherein
   w(i) is the sampled weight fraction in wt % with regard to the total sample weight in a-TREF analysis of a sample (i) taken at temperature T(i), where T(i)>30° C., the area under the a-TREF curve being normalised to surface area=1 for T(i)>30° C.; and
   T(i) is the temperature at which sample (i) is taken in a-TREF analysis, in ° C.

The polymer as used in the bi-directionally oriented film that is used in the present invention may for example be a linear low-density polyethylene. For example, the polymer may be a linear low-density polyethylene produced using a Ziegler-Natta type catalyst. The polymer as used in the present invention may for example be produced using a gas-phase polymerisation process, using a slurry-phase polymerisation process, or using a solution polymerisation process.

The polymer in the bi-directionally oriented film may for example comprise ≥80.0 wt % of moieties derived from ethylene and/or ≥5.0 wt % and <20.0 wt % of moieties derived from 1-hexene, with regard to the total weight of the polymer. Preferably, the polymer comprises ≥85.0 wt % of moieties derived from ethylene, more preferably ≥88.0 wt %. Preferably, the polymer comprises ≥80.0 wt % and ≤99.0 wt % of moieties derived from ethylene, more preferably ≥85.0 wt % and ≤95.0 wt %, even more preferably ≥88.0 wt % and ≤93.0 wt %.

The quantity of 1-hexene derived moieties in the polyethylene may be measured by ¹³C NMR on a Bruker Avance 500 spectrometer equipped with a cryogenically cooled probe head operating at 125° C., whereby the samples are dissolved at 130° C. in C₂D₂Cl₄ containing DBPC as stabiliser.

The polymer in the bi-directionally oriented film may for example comprise ≥5.0 wt %, preferably ≥7.0, wt %, more preferably ≥8.0 wt %, even more preferably ≥9.0 wt %, of moieties derived from 1-hexene, with regard to the total weight of the polymer. Preferably, the polymer comprises moieties derived from ethylene and ≥5.0 wt %, preferably ≥7.0, wt %, more preferably ≥8.0 wt %, even more preferably ≥9.0 wt %, of moieties derived from 1-hexene. More preferably, the polymer comprises moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

For example, the polymer in the bi-directionally oriented film may comprise ≥80.0 wt % of moieties derived from ethylene and ≥5.0 wt %, preferably ≥7.0, wt %, more preferably ≥8.0 wt %, even more preferably ≥9.0 wt %, of moieties derived from 1-hexene. Preferably, the polymer comprises ≥80.0 wt % of moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

In a certain embodiment, the polymer as used in the bi-directionally oriented film consists of moieties derived from ethylene and moieties derived from 1-hexene. For example, the polymer may consist of moieties derived from ethylene and ≥5.0 wt %, preferably ≥7.0, wt %, more preferably ≥8.0 wt %, even more preferably ≥9.0 wt %, of moieties derived from 1-hexene. Preferably, the polymer consists of moieties derived from ethylene and ≥5.0 wt % and ≤20.0 wt %, preferably ≥7.0, wt % and ≤17.0 wt %, more preferably ≥8.0 wt % and ≤15.0 wt %, even more preferably ≥9.0 wt % and ≤13.0 wt %, of moieties derived from 1-hexene.

It is in certain embodiments of the present invention preferred that the polymer has a particular degree of long-chain branching. Long-chain branching, in the context of the present invention, is to be understood to reflect the presence of certain polymeric side chains that do not originate from incorporation of comonomers, but may for example be caused by reaction of polymeric chains comprising unsaturations with a further growing chain at a catalytic site. In certain embodiments, a certain presence of such long-chain branching is desirable. An indicator for the presence of long-chain branching, in the context of the present invention, may for example be the storage modulus G′ at certain loss modulus G″. A certain high storage modulus at defined loss modulus indicates the presence of a certain quantity of long-chain branching in the polymer. Particularly preferred indicators for the presence of a certain degree of long-chain branching are the storage modulus at loss modulus of 10.0 kPa, and the storage modulus at loss modulus of 1.0 kPa. The storage modulus and the loss modulus may for example be determined in accordance with ISO 6721-10 (2015).

For example, the polymer in the bi-directionally oriented film may have a storage modulus determined at loss modulus of 10.0 kPa of >2.0 kPa, preferably >2.2 kPa, more preferably >2.5 kPa. For example, the polymer may have a storage modulus determined at loss modulus of 1.0 kPa of >50 Pa, preferably >75 Pa, more preferably >100 Pa. For example, the polymer may have a storage modulus determined at loss modulus of 1.0 kPa of >50 Pa, preferably >75 Pa, more preferably >100 Pa, and <150 Pa. For example, the storage modulus at loss modulus of 10.0 kPa may be >2.0 kPa and the storage modulus at loss modulus of 1.0 kPa may be >50 Pa, preferably the storage modulus at loss modulus of 10.0 kPa is >2.5 kPa and the storage modulus at loss modulus of 1.0 kPa is >50 and <150 Pa. The storage modulus and the loss modulus may be determined in accordance with ISO 6721-10 (2015) at a temperature of 190° C.

The polymer in the bi-directionally oriented film may for example comprise <250, preferably <200, or >100 and <250, unsaturations per 1000000 chain carbon atoms, wherein the unsaturations are determined as the sum of the vinyl unsaturations, vinylene unsaturations, vinylidene unsaturations, and triakyl unsaturations, determined via ¹H NMR. The number of unsaturations may be measured by ¹H NMR on a Bruker Avance 500 spectrometer equipped with a cryogenically cooled probe head operating at 125° C., whereby the samples are dissolved at 130° C. in C₂D₂Cl₄ containing DBPC as stabiliser.

The polymer in the bi-directionally oriented film may for example have an M_{w}/Mₙ ratio of >4.0, preferably >4.0 and <10.0, more preferably >5.0 and <8.0. For example, the polymer may have an M_{z}/Mₙ ratio of >15.0, preferably >15.0 and <40.0, preferably >20.0 and <30.0, wherein Mₙ is the number average molecular weight, M_{w} is the weight average molecular weight, and M_{z} is the z-average molecular weight, as determined in accordance with ASTM D6474 (2012). For example, the polymer may for example have an M_{w}/Mₙ ratio of >4.0, preferably >4.0 and <10.0 and an M_{z}/Mₙ ratio of >15.0, preferably >15.0 and <40.0.

It is preferred that for the polymer as used in the bi-directionally oriented film, in the range of log(M_{w}) between 4.0 and 5.5, the slope of the curve of the number of CH₃ branches per 1000 C atoms versus the log(M_{w}) is negative, wherein the number of CH₃ branches is determined via SEC-DV with and IR5 infrared detector, in accordance with ASTM D6474 (2012).

The polymer in the bi-directionally oriented film may have an M_{w} of for example >75 kg/mol, preferably >100 kg/mol, such as >75 and <200 kg/mol, preferably >100 and <150 kg/mol. The polymer may have an Mₙ of for example >15 kg/mol, preferably >20 kg/mol, such as for example >15 and <40 kg/mol, preferably >20 and <30 kg/mol. The polymer may have an M_{z} of >300 kg/mol, preferably >400 kg/mol, such as >300 and <700 kg/mol, preferably >400 and <650 kg/mol. Such characteristics of M_{w}, M_{z} and/or Mₙ may contribute to the improved stretchability of the film produced using the polymer of the invention.

The bi-directionally oriented film may for example comprise a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, preferably ≥11.0 wt %, with regard to the total weight of the polymer; and
(d) a fraction eluted in a-TREF at a temperature>94.0° C. of ≥20.0 wt %, with regard to the total weight of the polymer; and preferably
(e) a fraction eluted in a-TREF at a temperature>30.0° C. and ≤94.0° C. of ≥40.0 and ≤64.0 wt %, with regard to the total weight of the polymer.

In a certain embodiment, the invention also relates to a package comprising a bi-directionally oriented polyethylene film, wherein the bi-directionally oriented film comprises a polymer having moieties derived from ethylene and moieties derived from 1-hexene, wherein the polymer has:
(a) a density of ≥916 and ≤925 kg/m³ as determined in accordance with ASTM D792 (2008);
(b) a melt mass-flow rate of ≥0.6 and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥11.0 wt %, with regard to the total weight of the polymer; and
(d) a fraction eluted in a-TREF at a temperature>94.0° C. of ≥20.0 wt %, with regard to the total weight of the polymer; and
(e) a fraction eluted in a-TREF at a temperature>30.0° C. and ≤94.0° C. of ≥40.0 and ≤64.0 wt %, with regard to the total weight of the polymer.

The package may for example comprise a bi-directionally oriented film that is oriented in the machine direction to a degree of between 3 and 10, and/or the film is oriented in the transverse direction to a degree of between 5 and 15, wherein the degree of orientation is the ratio between the dimension of the film in the particular direction subsequent to the orientation and the dimension prior to the orientation.

In certain of its embodiments, the invention also relates to a process for the production of package comprising a bi-directionally oriented film.

For example, the invention also relates in a certain embodiment to a process for the production of a package comprising a bi-directionally oriented film comprising a polymer having moieties derived from ethylene and moieties derived from 1-hexene, wherein the polymer has:
(a) a density of ≥916 and ≤925 kg/m³ as determined in accordance with ASTM D792 (2008);
(b) a melt mass-flow rate of ≥0.6 and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥11.0 wt %, with regard to the total weight of the polymer; and
(d) a fraction eluted in a-TREF at a temperature>94.0° C. of ≥20.0 wt %, with regard to the total weight of the polymer; and
(e) a fraction eluted in a-TREF at a temperature>30.0° C. and ≤94.0° C. of ≥40.0 and ≤64.0 wt %, with regard to the total weight of the polymer.

The film may for example have an orientation in the machine direction of at least 4.0. In the context of the present invention, orientation may also be referred to as stretch. Orientation in the machine direction is to be understood to be the ratio of a the length in the machine direction of a certain quantity of material after having been subjected to a stretching force in the machine direction to the length that that very same quantity of material had prior to having been subjected to that stretching force in the machine direction.

The film may for example have an orientation in the transverse direction of at least 8. Orientation or stretch in the transverse direction is to be understood to be the ratio of the width of the film after having been subjected to a stretching force in the transverse direction to the width of the film prior to having been subjected to that stretching force in the transverse direction.

Stretching in the transverse direction may for example be achieved by clamping the film in clamps positioned on either side of the film at certain distance intervals, applying a certain heat to the film to ensure the film is at a certain temperature, and applying an amount of force onto the clamps outwards from the plane of the film in the transverse direction. Such stretching may for example be done in a continuous operation.

The bi-directionally oriented film may for example comprise >80.0 wt % of the polymer, preferably >85.0 wt %, preferably >90.0 wt %, more preferably >95.0 wt %, for example >80.0 and <98.0 wt %, or >90.0 and <98.0 wt %, with regard to the total weight of the bi-directionally oriented film.

In the package according to the invention, a sealing layer may in certain embodiments be present on the surface of the first layer that is positioned towards the inside of the package. For example, the package may be a heat-sealed bag.

The sealing layer may for example comprise a first polyethylene and optionally a second polyethylene, wherein the first polyethylene has:
a fraction of material that is eluted in analytical temperature rising elution fractionation (a-TREF) at a temperature>94.0° C. of ≤5.0 wt %, preferably ≤1.0 wt %, with regard to the total weight of the first polyethylene; and/or
a shear storage modulus G′ determined at a shear loss modulus G″=5000 Pa of >700 Pa, G′ and G″ being determined in accordance with ISO 6721-10 (2015) at 190° C.; and/or
a chemical composition distribution broadness (CCDB) of ≥5.0, preferably ≥10.0, preferably ≥15.0, preferably ≥20.0, preferably ≥5.0 and ≤30.0.

The sealing layer may for example comprise ≥15.0 wt %, ≥25.0 wt %, ≥50.0 wt %, ≥75.0 wt %, or ≥85.0 wt %, of the first polyethylene, with regard to the total weight of the sealing layer. The sealing layer may for example comprise ≥15.0 and ≤50.0 wt % of the first polyethylene, with regard to the total weight of the sealing layer. The sealing layer may for example comprise ≥15.0 and ≤50.0 wt % of the first polyethylene, with regard to the total weight of the sealing layer, and a fraction of the second polyethylene. The sealing layer may in certain embodiments contain the first polyethylene as the sole polyethylene material. For example, the sealing layer may comprise ≥30.0 and ≤99.0 wt %, or ≥30.0 and ≤97.0 wt %, of the first polyethylene.

The first polyethylene may for example comprise ≥80.0 wt % of moieties derived from ethylene and/or ≥5.0 wt % and <20.0 wt % of moieties derived from 1-octene, with regard to the total weight of the first polyethylene.

The second polyethylene may for example be a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, preferably ≥11.0 wt %, with regard to the total weight of the polymer; and
(d) a fraction eluted in a-TREF at a temperature>94.0° C. of ≥20.0 wt %, with regard to the total weight of the polymer; and preferably
(e) a fraction eluted in a-TREF at a temperature>30.0° C. and ≤94.0° C. of ≥40.0 and ≤64.0 wt %, with regard to the total weight of the polymer.

It is preferred that the second polyethylene in the sealing layer is equal to the polymer in the bi-directionally oriented film.

The invention also in an certain embodiment relate to the use of a bi-directionally oriented film comprising a polymer having moieties derived from ethylene and moieties derived from 1-hexene, wherein the polymer has:
(a) a density of ≥910 and ≤930 kg/m³, preferably ≥916 and ≤925 kg/m³, as determined in accordance with ASTM D792 (2008);
(b) a melt mass-flow rate of ≥0.2, preferably ≥0.5 or ≥0.6, and ≤5.0 g/10 min, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, preferably ≥11.0 wt %, with regard to the total weight of the polymer; and
(d) a fraction eluted in a-TREF at a temperature>94.0° C. of ≥20.0 wt %, with regard to the total weight of the polymer; and preferably
(e) a fraction eluted in a-TREF at a temperature>30.0° C. and ≤94.0° C. of ≥40.0 and ≤64.0 wt %, with regard to the total weight of the polymer;
   for improvement of retention of mechanical properties and shape under load of a bag for containing bulk products.

The bag for packaging bulk products may for example have a volume of between 5 and 100 litres, for example of between 10 and 50 litres, such as of between 10 and 30 litres. The bag may for example comprise the bulk products. For example, the bag may comprise between 5 and 50 kg of bulk products, preferably between 10 and 30 kg, such as 10, 15, 20 or 25 kg. The bulk products may for example be granular bulk products, for example granular bulk products having an average particle size of between 0.5 and 10.0 mm, for example of between 1.0 and 7.0 mm. The bulk products may for example be plastic pellets; fertilisers; garden soil; wood chips; dry, powdery food products such as flour or freeze-dried milk; and inorganic powders such as sand, talcum powders, or other filler materials for thermoplastic polymer materials. In a typical embodiment, the invention relates to a bag for packaging bulk products wherein the bag has a volume of between 10 and 50 litres, and wherein the bulk products are plastic pellets. Alternatively, the bag according to the invention may be used in bag-in-box solutions as a liner.

### EXAMPLES

### Production of Bi-Directionally Oriented Polyethylene Films (BOPE Films)

A multi-layer A-B-C polyethylene film was produced via cast extrusion using twin-screw extruders wherein the core layer B was extruded at 60 kg/h and each of layer A and C via separate extruders at 6.0 kg/h each, resulting in a 3-layer structure comprising 7 wt % of layer A, 86 wt % of layer B, and 7 wt % of layer C. Extrusion was performed at 260° C. The cast film was extruded via a die with a die gap of 3.0 mm, at a speed of 9 m/min.

Upon extrusion, the film was cooled via a water bath. The film was oriented in machine direction via multiple orientation rolls having a temperature of between 66 and 96° C., to a degree of stretching of 12 in the machine direction. Subsequently the film was subjected to stretching in the transverse direction at temperatures from 146° C. decreasing to 110° C., to obtain a bi-directionally oriented film (film 1) having a thickness of 19 μm. The film was subject to corona treatment at 25 W.min/m². Similarly, at increased throughput, a film having a thickness of 40 μm was produced (film 4).

### Formulation of BOPE Films:

Layer A: 72 wt % SABIC BX202, 3 wt % Constab AB06001LD, 25 wt % SABIC COHERE 8112
Layer B: 100 wt % SABIC BX202
Layer C: 97 wt % SABIC BX202, 3 wt % Constab AB06001LD

### Production of Bi-Directionally Oriented Polypropylene Films (BOPP Films)

A multi-layer A-B-C polypropylene film was produced via cast extrusion using twin-screw extruders wherein the core layer B was extruded at 52 kg/h and each of layer A and C via separate extruders at 6.0 kg/h each, resulting in a 3-layer structure comprising 7 wt % of layer A, 86 wt % of layer B, and 7 wt % of layer C. Extrusion was performed at 260° C. The cast film was extruded via a die with a die gap of 3.0 mm, at a speed of 9 m/min.

Upon extrusion, the film was cooled via a water bath. The film was oriented in machine direction via multiple orientation rolls having a temperature of between 80 and 106° C., to a degree of stretching of 12 in the machine direction. Subsequently the film was subjected to stretching in the transverse direction at temperatures from 190° C. decreasing to 160° C., to obtain a bi-directionally oriented film having a thickness of 25 μm. The film was subject to corona treatment at 24 W.min/m².

### Formulation of BOPP Film 2:

Layer A: 98 wt % Adsyl 5C30F, 2 wt % Schulman AB PP 05 SC
Layer B: 100 wt % SABIC 521P
Layer C: 98 wt % Adsyl 5C30F, 2 wt % Schulman AB PP 05 SC

### Production of Blown Film

A monolayer blown film (Film 3) was produced using SABIC BX202 using a Kuhne blown film extruder, operated at 96 RPM and fed with 24.8 kg/h of the polyethylene, at an extruder temperature of 200° C. The pressure before the filter was 113 bar, after the filter 74 bar. The film extrusion equipment was provided with a 120 mm die having a die gap of 2.3 mm. The line was operated with a freeze line height of 30 cm, and a blow-up ration of 2.5, with a winder speed of 18 m/min. The obtained film had a thickness of 25 μm.

A further blown film (film 5) was produced as 3-layer film, having a thickness of 60 μm, having an A/B/C construction. The blown film extrusion line was fed by 3 extruders, for each layer, wherein layer A was of formulation 75 wt % SABIC SUPEER 7118NE and 25 wt % SABIC LDPE 2501N0; layer B of 75 wt % SABIC HDPE F04660 and 25 wt % SABIC LDPE 2501N0; and layer C of 25 wt % SABIC COHERE S100 and 75 wt % SABIC LDPE 2501N0. The film 5 consisted of 30 wt % layer A (17 μm); 60 wt % layer B (35 μm); 10 wt % layer C (8 μm). The combined output of the extruders was 200 kg/h. Winder speed was 23 m/min; further conditions as for film 3.

Of the films 1-3 as prepared above, the below properties were determined:

| | Film 1 | Film 2 | Film 3 |
|---|---|---|---|
| Example | BOPE | BOPP | Blown PE |
| Thickness (μm) | 19 | 25 | 25 |
| Impact strength 23° C. (g/25 μm) | 508 | 954 | 87 |
| Tensile strength at break MD at −25° C. (MPa) | 59 | 154 | 86 |
| Tensile strength at break MD at 23° C. (MPa) | 39 | 121 | 62 |
| Elongation at break MD at −25° C. (%) | 240 | 161 | 603 |
| Elongation at break MD at 23° C. (%) | 288 | 191 | 556 |
| Tear Resistance MD (g/25 μm) | 22 | 8 | 291 |
| Tear Resistance TD (g/25 μm) | 5 | 4 | 704 |
| Puncture resistance at 23° C. (N/25 μm) | 118 | 247 | 72 |
| Puncture resistance at −25° C. (N/25 μm) | 109 | 217 | 43 |
| Seal strength of seal produced at 80° C. (N/15 mm) | 0.07 | 0.07 | 0.08 |
| Seal strength of seal produced at 90° C. (N/15 mm) | 0.57 | 0.17 | 0.41 |
| Seal strength of seal produced at 100° C. (N/15 mm) | 5.8 | 0.51 | 4.9 |
| Seal strength of seal produced at 110° C. (N/15 mm) | 7.0 | 3.5 | 5.8 |
| Seal strength of seal produced at 120° C. (N/15 mm) | 10.5 | 3.2 | 6.0 |

### Wherein:

The impact strength was determined in accordance with ASTM D1709A (2016);
The tensile strength at break MD is determined on the film in the machine direction, in accordance with ASTM D882 (2018), using an initial sample length of 50 mm and a testing speed of 500 mm/min;
The elongation at break MD is determined on the film in the machine direction, in accordance with ASTM D882 (2018), determined at room temperature using an initial sample length of 50 mm and a testing speed of 500 mm/min;
Tear resistance is measured in the machine direction (MD) and the transverse direction (TD) in accordance with the method of ASTM D1922 (2015).
Puncture resistance is the maximum force as determined in accordance with ASTM D5748-95 (2012), expressed in N;
The heat seal strength was determined in accordance with ASTM F88, using method A, on specimens of 15 mm width. Fin-seals were prepared according ASTM F2029 at different temperatures. Two samples of the same film were compressed together, with layer C of the first film sample contacting layer C of the second film sample. Seals were produced by applying a force of 3.0 bar for 1.0 sec, wherein the films were protected with a 25 μm cellophane sheet. The press used for preparing the seal was heated to various temperatures to identify the strength of the seal when produced at different temperatures. The seal strength was tested using a tensile testing machine with a testing speed of 200 mm/min, and a grip distance of 10 mm. The maximum load was recorded as the seal strength.

1. A bag comprising a film, wherein the film comprises at least a first layer, wherein the first layer is a bi-directionally oriented polyethylene film layer, wherein the bag comprises ≥90.0 wt % of polyethylene with regard to the total weight of the film.

2. The bag according to claim 1, wherein the bag is a bag for packaging bulk products or for packaging frozen matter.

3. The bag according to claim 1, wherein the film is a single-layer film, or wherein the film comprises multiple layers formed by lamination of multiple bi-directionally oriented polyethylene film layers.

4. The bag according to claim 1, wherein the film has a thickness of ≥15 and ≤75 μm.

5. The bag according to claim 3, wherein:
if the film is a laminate comprising 2 layers of the bi-directionally oriented polymer film, each layer has a thickness of ≥15 and ≤40 μm; and
if the film is a laminate comprising 3, 4 or 5 layers of the bi-directionally oriented polymer film, each layer has a thickness of ≥15 and ≤30 μm.

6. The bag according to claim 3, wherein the layers are bonded together via lamination.

7. The bag according to claim 3, wherein the laminated film is positioned such that, the first layer is positioned towards an inside of the bag, when compared to a second layer, and the second layer is positioned towards an outside of the bag, when compared to the first layer.

8. The bag according to claim 3, wherein a printed layer is positioned in the laminate on a surface of the first layer that is positioned towards an outside of the bag.

9. The bag according to claim 1, wherein the bi-directionally oriented film comprises a polymer having moieties derived from ethylene and moieties derived from 1-hexene, wherein the polymer has:
(a) a density of ≥910 and ≤930 kg/m³, as determined in accordance with ASTM D792 (2008);
(b) a melt mass-flow rate of ≥0.2, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, with regard to the total weight of the polymer; and
(d) a fraction eluted in a-TREF at a temperature>94.0° C. of ≥20.0 wt %, with regard to the total weight of the polymer.

10. The bag according to claim 9, wherein the polymer comprises ≥80.0 wt % of moieties derived from ethylene and/or ≥5.0 wt % and <20.0 wt % of moieties derived from 1-hexene, with regard to the total weight of the polymer.

11. The bag according to claim 9, wherein the polymer has an M_{w}/Mₙ ratio of >4.0, and/or wherein the polymer has an M_{z}/Mₙ ratio of >15.0, wherein Mₙ is the number average molecular weight, M_{w} is the weight average molecular weight, and M_{z} is the z-average molecular weight, as determined in accordance with ASTM D6474 (2012).

12. The bag according to claim 1, wherein a sealing layer is present on a surface of the first layer that is positioned towards an inside of the bag.

13. The bag according to claim 1, wherein the bag is a heat-sealed bag.

14. The bag according to claim 12, wherein the heat-sealed bag has a sealing layer comprising a first polyethylene and optionally a second polyethylene, wherein the first polyethylene has:
a fraction of material that is eluted in analytical temperature rising elution fractionation (a-TREF) at a temperature>94.0° C. of ≤5.0 wt %, with regard to the total weight of the first polyethylene; and/or
a shear storage modulus G′ determined at a shear loss modulus G″=5000 Pa of >700 Pa, G′ and G″ being determined in accordance with ISO 6721-10 (2015) at 190° C.; and/or
a chemical composition distribution broadness (CCDB) of ≥5.0.

15. The bag according to claim 14, wherein:
the sealing layer comprises ≥15.0 and ≤50.0 wt % or ≥30.0 and ≤97.0 wt % of the first polyethylene, with regard to the total weight of the sealing layer; and/or
the first polyethylene comprises ≥80.0 wt % of moieties derived from ethylene and/or ≥5.0 wt % and <20.0 wt % of moieties derived from 1-octene, with regard to the total weight of the first polyethylene.

16. The bag according to claim 13, wherein the second polyethylene is a polymer having moieties derived from ethylene and moieties derived from 1-hexene, wherein the polymer has:
(a) a density of ≥910 and ≤930 kg/m³, as determined in accordance with ASTM D792 (2008);
(b) a melt mass-flow rate of ≥0.2, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, with regard to the total weight of the polymer; and
(d) a fraction eluted in a-TREF at a temperature>94.0° C. of ≥20.0 wt %, with regard to the total weight of the polymer.

17. A method of improving retention of mechanical properties and shape under load of a bag for containing bulk goods, the method comprising producing a bi-directionally oriented film comprising a polymer having moieties derived from ethylene and moieties derived from 1-hexene, wherein the polymer has:
(a) a density of ≥910 and ≤930 kg/m³, as determined in accordance with ASTM D792 (2008);
(b) a melt mass-flow rate of ≥0.2, as determined in accordance with ASTM D1238 (2013) at a temperature of 190° C. under a load of 2.16 kg;
(c) a fraction that is eluted in analytical temperature rising elution fractionation (a-TREF) at a temperature≤30.0° C. of ≥8.0 wt %, with regard to the total weight of the polymer; and
(d) a fraction eluted in a-TREF at a temperature>94.0° C. of ≥20.0 wt %, with regard to the total weight of the polymer.

18. The bag according to claim 16, wherein the second polyethylene in the sealing layer is equal to the polymer in the bi-directionally oriented film.

19. The bag according to claim 16, wherein the polymer has a fraction eluted in a-TREF at a temperature>30.0° C. and ≤94.0° C. of ≥40.0 and ≤64.0 wt %, with regard to the total weight of the polymer.
